(19) United States
(12) Patent Application Publication
(10) Pub. No.: US 2005/0044223 A1
(43) Pub. Date: Feb. 24, 2005

(54) Method and apparatus for entitlement based dynamic sampling

(76) Inventor: Randy Meyerson, Seattle, WA (US)

Correspondence Address: SCHWABE, WILLIAMSON & WYATT, P.C.;PACWEST CENTER, SUITES 1600-1900, 1211 SW FIFTH AVENUE, PORTLAND, OR, 97204, US

(21) Appl. No.: 10/877,828

(22) Filed: Jun. 24, 2004

Related U.S. Application Data
(60) Provisional application No. 60/482,388, filed on Jun. 24, 2003.

(51) Int. Cl. G06F 15/16; G06F 15/173; H04J 3/18

(52) U.S. Cl. 709/225; 709/217; 709/219; 709/229

(57) ABSTRACT

A method and apparatus for entitlement based dynamic sampling includes receiving a request for a media resource, determining whether a requestor of the media resource is entitled to access the requested media resource, delivering the requested media resource in its entirety to the requestor if it is determined that the requestor is entitled to access the requested media resource, and dynamically generating a sample of the requested media resource and delivering the sample of the requested media resource to the requester if it is determined that the requestor is not entitled to access the requested media resource.

### RELATED APPLICATION

This application claims the benefit of U.S. Provisional Application No. 60/482,388 filed on Jun. 24, 2003.

### BACKGROUND OF THE INVENTION

1. Field of the Invention

The present invention relates generally to the field of computing. More specifically, the present invention relates to a method and apparatus for the dynamic delivery of media samples.

2. Background Information

With advances in integrated circuit, microprocessor, networking and communication technologies, an increasing number of digital computing devices are being networked together to facilitate the exchange of electronic information. Accordingly, traditional audio and video content providers such as radio and television studios, recording associations, independent recording artists, and so forth, are turning to digital communication networks such as the Internet for dissemination and distribution of media content.

As the Internet continues to prove to be a viable and desirable content distribution mechanism, content providers have begun to focus their attention on generating revenue from such network-based content distribution. Many content providers offer subscription services whereby a subscriber/consumer may pay a periodic or one time fee to the provider in exchange for the right to access a variety of media content. Other content providers have implemented a transactional content distribution model, whereby consumers pay a fee for each media resource they wish to access. The transactional fees charged by a given content provider may be determined based upon a number of factors such as popularity, quality and length of the media, to name just a few.

Very often, however, consumers may wish want to “try out” the content delivery services or preview the content offered by a particular provider before subscribing to the provider's services or before paying to access the particular media content. Knowing this, many content providers have offered temporary or trial memberships to consumers to give consumers a period of time to become familiar with the particular content provider's services before requiring the consumers to subscribe to the service. Some content providers have even provided separate preview versions of the media that consumers may access free of charge. This way, a consumer is often able to make an informed decision (e.g. via the preview) as to whether they wish to purchase access to the full version of the media prior to the purchase process occurring.

Unfortunately, however, current methods available for providing content previews require that a separate and distinct static preview resource be generated prior to the request being received and stored in association with the original full-length media resource prior to being accessed by a consumer. Not only does this methodology require additional storage facilities to store both the full length versions of the media as well as the preview version, the preview resources must additionally be manually generated in advance of distribution. Such manual generation does not scale well with the large number of consumers that a given site may encounter, and manual generation may artificially limit the number of media resource previews made available to consumers accordingly.

### BRIEF DESCRIPTION OF DRAWINGS

The present invention will be described by way of exemplary embodiments, but not limitations, illustrated in the accompanying drawings in which like references denote similar elements, and in which:

FIG. 1 illustrates an environment for dynamic generation of media samples, in accordance with one embodiment of the invention;

FIG. 2 illustrates an example server-side architecture including one embodiment of the sample processing logic shown in FIG. 1;

FIG. 3 illustrates an example data structure suitable for storing a variety of request-affiliated attributes including sample attributes, in accordance with one embodiment of the invention;

FIG. 4 illustrates an example request generation flow diagram in accordance with one embodiment of the invention;

FIG. 5 illustrates an example operational flow for one embodiment of a dynamic sample generation server;

FIG. 6 illustrates an example environment to facilitate multiple entity control of dynamic media resource sampling, in accordance with one embodiment of the invention;

FIGS. 7a and 7c each illustrate a logical block diagram of one embodiment of sample processing logic to facilitate in the multiple entity control of dynamic media resource sampling;

FIG. 7b illustrates an example data structure suitable for storing a variety of request-affiliated attributes including media resource host addresses, in accordance with one embodiment of the invention;

FIG. 8 illustrates an operational flow for one embodiment of a server equipped with sample processing logic 606 to facilitate multiple entity sample processing;

FIG. 9 illustrates an operational flow for one embodiment of a server equipped with sample processing logic 636 to further facilitate multiple entity sample processing; and

FIG. 10 illustrates an example computer system suitable for practicing the present invention.

### DETAILED DESCRIPTION OF EMBODIMENTS OF THE INVENTION

The present invention describes a method and apparatus for entitlement based dynamic sampling. In the description to follow, various aspects of the present invention will be described, and specific configurations will be set forth. However, the present invention may be practiced with only some or all aspects, and/or without some of these specific details. In other instances, well-known features are omitted or simplified in order not to obscure the present invention.

The description will be presented in terms of operations performed by a processor based device consistent with the manner commonly employed by those skilled in the art to convey the substance of their work to others skilled in the art. As is well understood by those skilled in the art, the quantities take the form of electrical, magnetic, or optical signals capable of being stored, transferred, combined, and otherwise manipulated through mechanical, electrical and/or optical components of the processor based device.

Various operations will be described as multiple discrete steps in turn, in a manner that is most helpful in understanding the present invention, however, the order of description should not be construed as to imply that these operations are necessarily order dependent. In particular, these operations need not be performed in the order of presentation.

The description repeatedly uses the phrase “in one embodiment”, which ordinarily does not refer to the same embodiment, although it may. The terms “comprising”, “including”, “having”, and the like, as used in the present application, are synonymous.

Overview

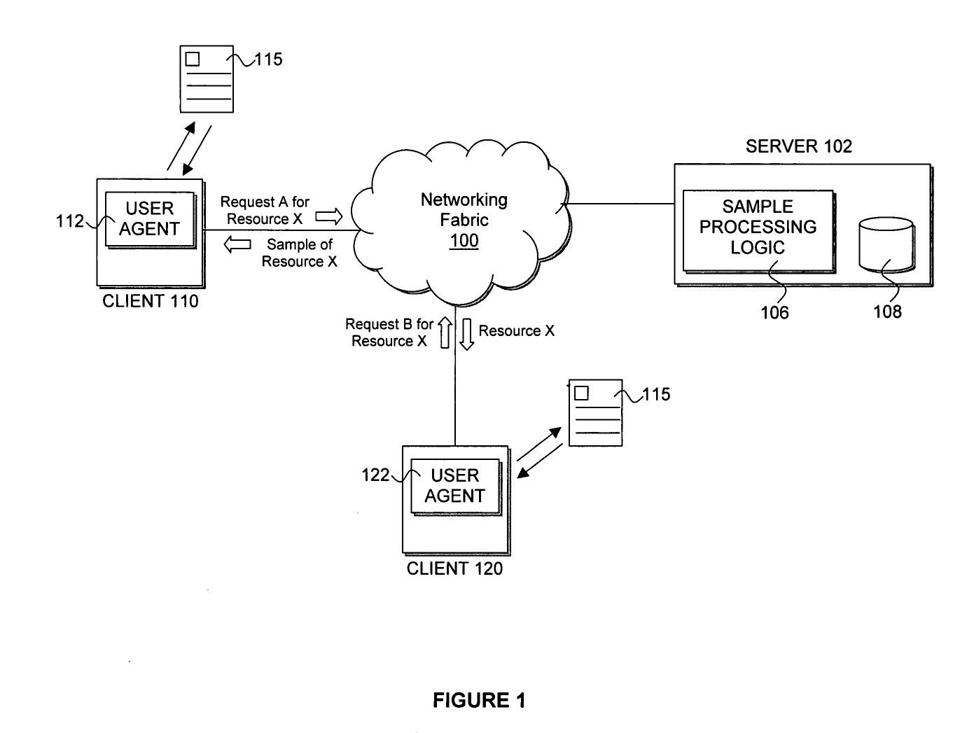

FIG. 1 illustrates an environment for dynamic generation of media samples, in accordance with one embodiment of the invention. As illustrated, server 102, equipped with sample processing logic 106 and data store 108, is communicatively coupled to clients 110 and 120 via networking fabric 100, where networking fabric 100 may represent one or more interconnected data networks, such as, but not limited to the Internet or World Wide Web. In one embodiment, server 102 may provide media resources and dynamically generated samples of media resources to clients 110 and 120 in response to media resource requests received from the respective clients. Client 110, client 120 and server 102 may each represent a broad range of digital systems known in the art, including but not limited to devices such as wireless mobile phones, palm sized personal digital assistants, notebook computers, desktop computers, set-top boxes, and game consoles.

Each of clients 110 and 120 may be equipped with a user agent (112 and 122, respectively), such as a web browser or media rendering/player application to access electronic document/web page 115 to view content containing references to media resources, and to formulate and transmit network requests for media resources to server 102. The terms “media resource” and “media content”, are each interchangeably intended to broadly refer to digital or analog data such as, but not limited to audio and video (including motion video and still images) clips, files, and streams, whether alone or combined, that may be accessible by a user agent/client.

In accordance with one embodiment, server 102 may receive media resource requests from clients 110/120 and determine whether the requestor is entitled to access the requested media resource based upon one or more attributes of the request or even the requester. Sample processing logic 106 may then further determine whether to deliver the requested media resource to the requesting client or a dynamically generated sample of the requested media resource to the requesting client, based upon e.g. whether or not the requestor is entitled to access the requested media resource. For example, in accordance with one embodiment, a first client (e.g. client 110) may request a particular media resource “X” via electronic document/web page 115, while a second client (e.g. client 120) may request the same media resource “X” from the same electronic document (e.g. 115). In response, however, client 110 may receive the requested resource “X” in its entirety, while client 120 may only receive a sample of resource “X” due to e.g. limited entitlements of client 120. In other embodiments, server 102 may produce and deliver (or facilitate the delivery of) media resource samples independent of the requestor's entitlements.

The term “sample” or “media resource sample” is intended to refer to a portion, section, or segment of a given media resource. In one embodiment, a media resource sample may be generated through the dynamic identification (i.e. without further human intervention) of a portion of the given media resource. Furthermore, the term “requester” is used herein to broadly refer to an originator of a request including but not limited to a device such as client 110/120, a software component or application such as user agent 112/122, or an individual such as the requesting user operating client 110/120 that initiates a media resource request.

The Request

In one embodiment, clients 110 and 120 may each request delivery of a particular media resource from server 102. The requested media resource may, for example, be identified by one or more uniform resource indicators (URls) or one or more uniform resource locators (URLs). In one embodiment, a URL may take the following form:
“PROTOCOL://<HOST>:<PORT>/<PATH>?<SEARCHPART>”.

The <protocol> field tells the server how to retrieve the requested resource, the <host> field represents the fully qualified domain name of a network host such as server 102, or its IP address, and the <port> field indicates the port number to connect to on the host. The remainder of the locator consists of the “URL-Path”, which supplies the details of how the specified resource can be accessed on the host. In addition, the <searchpart> is a query string that may be used to pass information to the <host>. In one embodiment, the <searchpart> of a URL contained within electronic document 115 may contain a partner identifier (PID) that indicates (whether directly or indirectly) a particular content class to which the associated resource belongs. The term “content class” is used herein to broadly describe a logical or physical grouping of information or media content into one or more shared categories. The classification categories may be predefined by e.g. a content provider or other party, or the classification categories may be arbitrarily and/or dynamically defined based on one or more criteria, for example. In one embodiment, each media resource may be classified into one or more content classes or categories, and assigned a PID to facilitate identification of the assigned content class by server 102. In one embodiment, each content directory may be represented by a unique PID.

In one embodiment, the requested media resource may further be identified by one or more uniform resource indicators (URIs) or one or more uniform resource locators (URLs) that are associated with an HTML “Form”. For example, an HTML Form used to submit a request to server 102 may contain an ACTION attribute indicating a URI/URL associated with the requested media resource, a METHOD attribute indicating the type of method to use when submitting the data (e.g. whether it be a GET or POST method), an ENCTYPE attribute used to specify the media type used to encode the name/value pairs for transport, and a variety of optional INPUT attributes that enable Form customization to facilitate data collection.

To access a particular media resource, a user might, for example, select (via a user input device) a link displayed within electronic document 115 that corresponds to the particular media resource stored on server 102. In response, the corresponding user agent might then generate and transmit an HTTP request to server 102 in the following format:
[METH] [REQUEST-URI] HTTP/[VER]
[fieldname1]: [field-value1]
[fieldname2]: [field-value2]
[Request body, if any]

In such a request, “METH” is used to indicate the request method used (e.g. “GET” or “POST”), “REQUEST-URI” field identifies the requested resource on the server, and “VER” indicates the version of HTTP used. If a GET method is used, the Form data is typically sent to the server with a “?” followed by the form_data appended to the URI specified in the ACTION attribute. With a POST method, however, the Form data is typically sent in the body of the request. Furthermore, the fieldname/field-value pairs represent header fields through which the user agent may additionally provide the server with requestor-specific attributes such as the name of the requesting user, the type and version of user agent employed, authorization information such as passwords and encryption keys, requestor entitlements/authorizations and so forth.

In one embodiment, the requestor-specific attributes may be supplied to the host (e.g. example server 102) in the form of an HTTP “Cookie”. In such an embodiment, the user agent may first compare the selected URI/URL with a list of Cookies stored on the client. If a match is found, a line containing the name/value pairs of matching cookies may then be included in the HTTP request. For example, an HTTP request that includes a URI/URL that matches a cookie might be formed as: Cookie: Name1=Opaque_String1; Name2=Opaque_String2, where any opaque string may be used to indicate the requestor-specific attributes described above.

Example Server Configuration

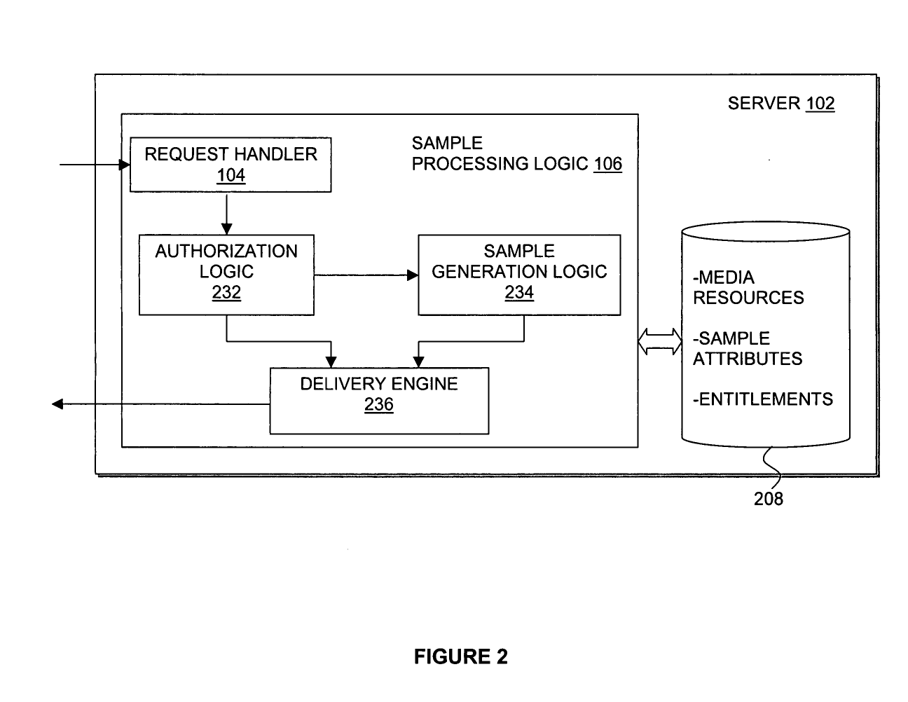

FIG. 2 illustrates an example server-side architecture including one embodiment of the sample processing logic shown in FIG. 1. Server 102 may include internal and/or external data store 208, request handler 204, authorization logic 232, sample generation logic 234, and delivery engine 236.

In one embodiment, request handler 204 may receive media resource requests for media resources stored in data store 208. The media requests may be formed in accordance with a variety of communication protocols and/or application-specific message formats such as HTTP, the real time streaming protocol (RTSP), the file transfer protocol (FTP), and so forth. In one embodiment, request handler 204 may be an HTTP daemon that waits for HTTP based requests from web clients such as clients 110/120. In one embodiment, request handler 204 may receive HTTP based requests that identify (either directly or indirectly) one or more of a particular media resource, a content class to which the indicated media resource belongs, and one or more requestor-specific attributes. In one embodiment, the request may also directly or indirectly identify an entitlement level associated with the requester.

In one embodiment, request handler 204 may provide all or a portion of the request to authorization logic 232. For example, after processing any existing protocol-specific transport information, request handler 204 may identify to authorization logic 232, one or more references to the requested media resource, the content class or a representation of the content class to which the media resource belongs, and the entitlement level or a representation of the entitlement level associated with the requestor.

In one embodiment, authorization logic 232 may access data store 208 to determine whether or not the requester is entitled to access the requested media resource based upon the content class to which the media resource belongs and/or an entitlement level associated with the requestor. In one embodiment, authorization logic 232 compares the entitlement level associated with the requestor with an entitlement level associated with the content class of the requested media resource stored within data store 208. In one embodiment, if the entitlement level associated with the requester is equal to or greater than the entitlement level stored within data store 208, the requestor may be deemed authorized to access the stored media resource. Otherwise, the requestor may not be deemed authorized to access the stored media resource. In one embodiment, if it is determined that the requestor is entitled to access the requested media resource, authorization logic 232 may provide the requested media resource stored in data store 208 (or a reference to the requested media resource) to delivery engine 236. Conversely, if it is determined that the requestor is not entitled to access the requested media resource, sample generation logic 234 may dynamically generate a sample of the requested media resource to be delivered to the requester.

In one embodiment, sample generation logic 234 may access data store 208 to identify one or more sample attributes to facilitate in the dynamic generation of the media resource sample. In one embodiment, the media resource sample may be dynamically generated by sample generation logic 234 and provided to delivery engine 236. In another embodiment, the media resource sample may be dynamically generated by delivery engine 236 based upon the one or more sample attributes provided to delivery engine 236 by e.g. sample generation logic 234. In one embodiment the sample attributes may represent a starting point and duration for the media resource sample and may be identified based upon the identified content class. In one embodiment, delivery engine 236 may represent a streaming media engine that streams media resources, including dynamically generated media resource samples to recipients. In another embodiment, delivery engine 236 may deliver the dynamically generated media resource samples to the requestor in the form of static data files.

In the event delivery engine 236 delivers a static data file to the requestor, sample generation logic 234 (or delivery engine 236) may access the stored media resource using e.g. an appropriate coder/decoder algorithm (i.e. CODEC-not shown). Sample generation logic 234 may then advance or index to the identified start time and capture or “sample” the identified length or amount of media as determined e.g. by the sample attributes. Thereafter, sample generation logic 234 or delivery engine 236 may package the media resource sample by adding the appropriate transport overhead as determined by e.g. the media resource sample's format and the communication protocol employed.

Although server 102 of FIG. 1 is shown to include the various components/logic blocks described above, it should be noted that the functionality of one or more of request handler 204, authorization logic 232, sample generation logic 234, and delivery engine 236 may be combined into fewer functional blocks than that pictured or further subdivided into additional functional components/logic blocks without departing from the spirit and scope of the invention. For example, all or part of the functionalities of authorization logic 232 and sample generation logic 234 may be integrated into a single s/w component or further subdivided into additional functional components/logic blocks. Furthermore, although request handler 204 is shown to be part of sample processing engine 106, request handler 104 may nonetheless be separate from sample processing engine 106. Additionally, data store 208 may represent one or more volatile or non-volatile data storage mechanisms/devices that may be internal or external to server 102.

Example Data Structure

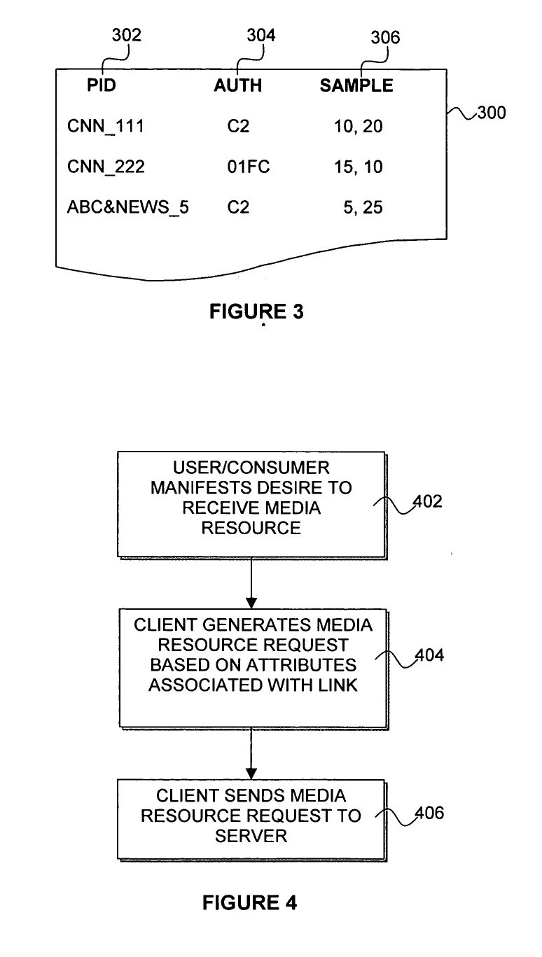

FIG. 3 illustrates an example data structure suitable for storing a variety of request-affiliated attributes including sample attributes in accordance with one embodiment of the invention. As shown, table 300 includes a number of entries/records, with each entry including a partner identifier (PID) 302 for use in identifying a particular class of media content, an authorization code (AUTH) 304 for use in identifying an entitlement level associated with the corresponding content class, and one or more sample attributes (SAMPLE) 306 for use in the dynamic generation of a media resource sample.

As described above in accordance with one embodiment, each content provider may assign an identifier such as a PID to each piece of content or a class of content the content provider wishes to make available for distribution. In turn, each PID may be associated with an authorization code/value (AUTH) that indicates an entitlement level for the associated content or content class. In one embodiment, a user may themselves be assigned an entitlement level commensurate with rights bestowed upon the user through e.g. an on-line account with a content provider or distributor. In one embodiment, users having entitlement levels that are deemed to be greater than or equal to the entitlement level associated with the requested media resource (e.g. as determined by the corresponding AUTH code) are entitled or authorized to access the corresponding media resource. Similarly, users having entitlement levels deemed to be less than the entitlement level associated with the requested media resource are not entitled or authorized to access the corresponding media resource. A variety of comparison criteria may be used to determine the relationships between the entitlement levels, and the entitlement levels need not necessarily be limited to numeric or alphanumeric representations, although they may. In one embodiment, the sample attributes may each indicate a start time and a duration time for a media sample, however, the sample attributes may similarly represent a sample end time, sample size, and so forth.

Example Embodiment

As described above, a content provider may assign a content identifier such as a PID shown in FIG. 3, to a particular class of media resources. In one embodiment, each class of media resources is associated with its own data directory, where similar types of media resources are grouped into shared directories. For example, media resources associated with particular type of “news” content may be assigned an identifier of “CNN_111”. In response to a user selecting a hypertext link corresponding to a media resource that is associated with that particular type of news content, an HTTP based request including the “CNN_111” identifier may be generated.

Upon receipt of the request, a server equipped with resource sample processing logic may identify the “CNN_111” identifier and access a data structure, such as table 300 of FIG. 3, to determine an appropriate response to the received request. In one embodiment, an entitlement level associated with the requester (as reflected by the request) may be compared to the entitlement level (e.g. “C2”) associated with the “CNN_111” identifier to determine whether the requestor is authorized to access the requested media resource. In one embodiment, the entire requested media resource may be delivered to the requestor if the entitlement level associated with the requestor is deemed to be equivalent to or greater than the entitlement level associated with the “CNN_111” identifier. On the other hand, if the entitlement level associated with the requestor is deemed to be less than the entitlement level associated with the “CNN_111” identifier, a sample of the requested media resource may instead be generated and delivered to the requester.

In one embodiment, sample attributes, such as those shown in FIG. 3, may be utilized in the generation of a media resource sample. For example, if the entitlement level associated with the requestor is deemed to be less than the entitlement level associated with the “CNN_111” identifier, sample generation logic of a server such as server 102 may utilize the sample attributes 306 to determine a starting point within the media resource for the sample and a sample duration time for the sample. In the illustrated example, the sample generation logic may, based upon the sample attributes, generate a sample of the requested media resource that starts at a point 10 seconds into the requested media resource and continues for a duration of 20 seconds. In addition to a single starting point and duration, the sample attributes may further include an indicator to indicate whether sampling is enabled/allowed for a particular media resource, or to indicate a sampling end point, a quantity of media content to sample, and so forth. Likewise, the sample attributes associated with a given content identifier may facilitate the generation of multiple samples for a given media resource.

Example Operational Flow for Request Generation

FIG. 4 illustrates an example request generation flow diagram in accordance with one embodiment of the invention. As shown, the process begins with a user indicating their desire to receive a media resource, block 400. In one embodiment, the user may manifest such a desire by selecting, via a user input device, a hypertext link associated with the desired media resource from a electronic document/web page 115. In response, the corresponding client (e.g. client 110/120 or a software requestor) generates a media resource request based upon e.g. attributes associated with the selected link, block 404. Next, the requesting client (also referred to as the requestor) sends the resource request to a server such as server 102. In one embodiment, the request is generated in the form of an HTTP request.

Example Operational Flow for Sample Generation

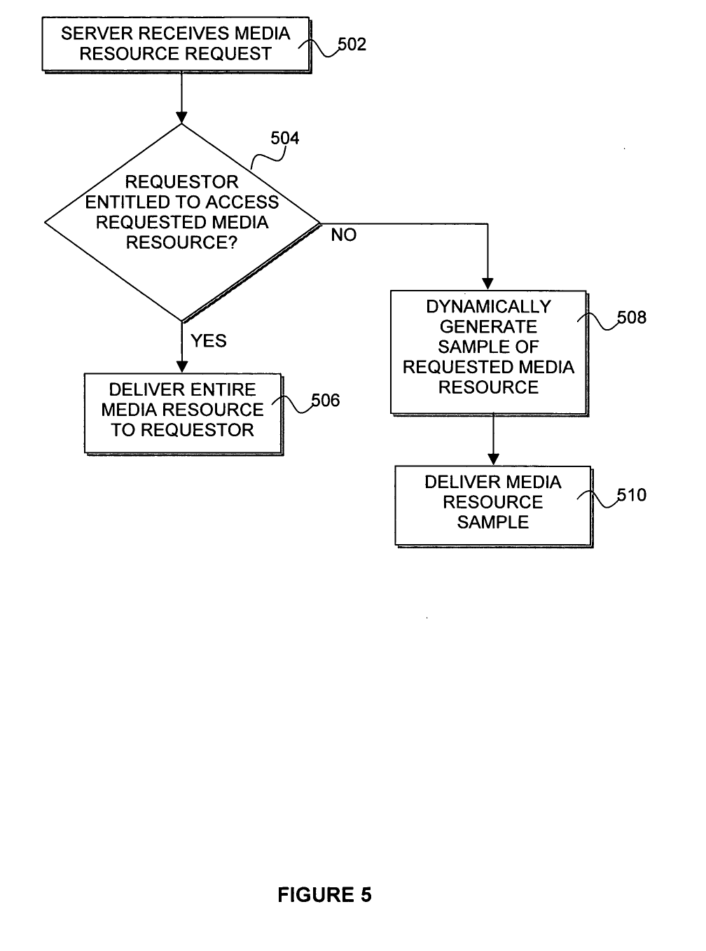

FIG. 5 illustrates an example operational flow for one embodiment of a dynamic sample generation server, such as server 102. As illustrated, the process begins with the server receiving a media resource request, block 502. Once the request is received, the server makes a determination as to whether the requestor is authorized to access the requested media resource, block 504. The determination may be based upon comparisons between entitlements for the resource and the requestor. If the requestor is authorized to access the requested media resource, the requested media resource is delivered to the requester in its entirety, block 506. However, if it is determined that the requestor is not authorized to access the requested media resource, a sample of the requested media resource may be dynamically generated from the requested media resource, block 508, and delivered to the requester, block 510. In one embodiment, the media resource sample is delivered to the requestor in the form of a static data file, whereas in another embodiment, the media resource sample is streamed to the requestor.

Multiple Entity Control for Dynamic Sampling

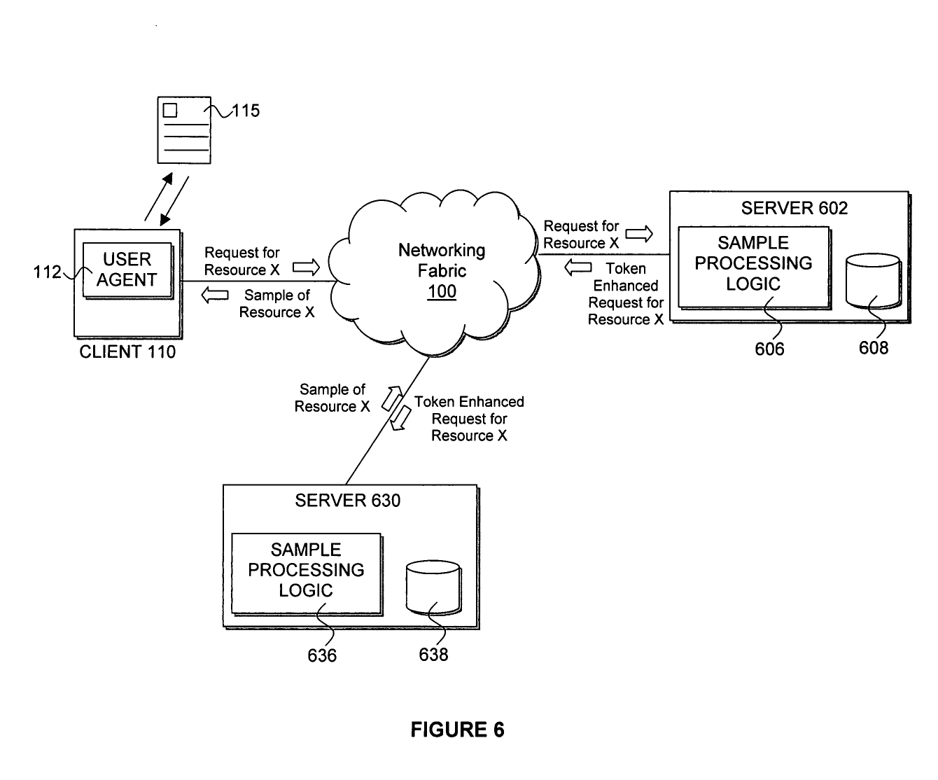

FIG. 6 illustrates an example environment to facilitate multiple entity control of dynamic media resource sampling, in accordance with one embodiment of the invention. As shown, server 602 including sample processing logic 606 and data store 608, and server 630 including sample processing logic 636 and data store 638, may be communicatively coupled to client 110 via networking fabric 100.

In one embodiment of the invention, client 110 may generate a media resource request and transmit the request to server 602. In one embodiment the media resource request may indicate a content class to which the requested media resource is associated and one or more requestor-specific attributes. The requestor-specific attributes may include, but are not limited to the name of the requesting user, the type and version of user agent employed, authorization information such as passwords and encryption keys, requester entitlements/authorizations and so forth.

In response to receiving the request, server 602 may identify one or more sample attributes corresponding to the indicated content class and, in turn, generate an obfuscated token based upon the one or more sample attributes and/or requestor-specific attributes. In one embodiment, server 602 may respond to the received request in a manner that causes the requestor to redirect the initial media resource request to another server (such as server 630) as indicated e.g. by server 602 in its response. For example, in response to an HTTP based media resource request received from a requester, server 602 may issue an HTTP response that includes a status code (such as 302, 303, 307 and so forth as defined in at least the following “Request for Comments” documents available from ‘http://www.rfc-editor.org’: RFC 1945, RFC 2616 and RFC 2068) indicating to the requestor that the requested resource temporarily resides under a different URI as indicated in the response. The requestor (e.g. client 110) may then resubmit the request to the server indicated by the token-equipped URI/URL included in the response to retrieve the requested media resource.

Multiple Entity Control Server-Side Architecture

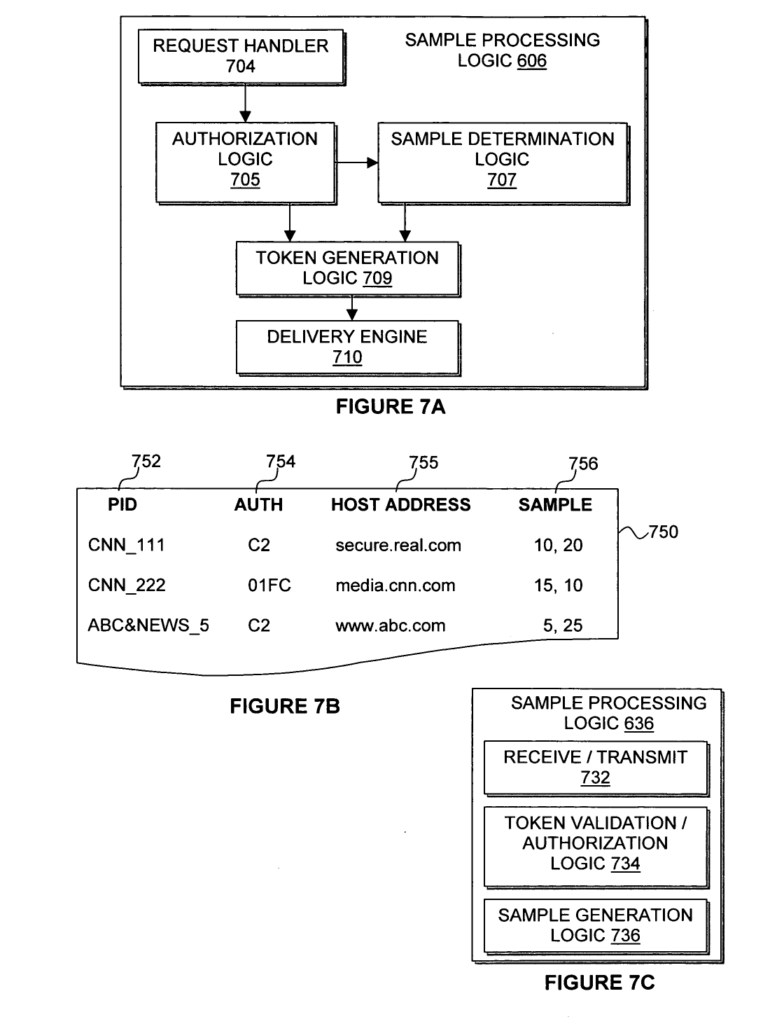

FIG. 7a illustrates a logical block diagram of one embodiment of sample processing logic 606 shown in FIG. 6 to facilitate multiple entity control of dynamic media resource sampling. In the illustrated embodiment, sample processing logic 606 may be equipped with request handler 704, authorization logic 705, sample determination logic 707, token generation logic 709, and delivery engine 710. As described above with respect to FIG. 2, request handler 704 may receive media resource requests for media resources stored in data store 608. In one embodiment, request handler 704 may receive HTTP based requests that identify (either directly or indirectly) one or more particular media resources, a content class to which the indicated media resource belongs, an entitlement level associated with the requestor, or one or more requestor-specific attributes. After receiving a media resource request, request handler 704 may provide authorization logic 705 with appropriate portions of the request to facilitate determining whether the corresponding requestor is authorized to access the requested media resource.

If is determined that the requestor is authorized to access the requested media resource, authorization logic 705 may then provide token generation logic 709 with one or more request-specific and/or requestor-specific attributes for use in generating an obfuscated token. If the requestor is not authorized to access the requested media resource, however, sample determination logic 707 may further identify (e.g. via data store 708) one or more sample attributes corresponding to the class of content to which the requested media resource is associated, and in turn, provide the sample attributes to token generation logic 709 for use in generating the obfuscated token. Token generation logic 709 may then generate the obfuscated token using the one or more requestor-specific attributes and/or one or more sample attributes as may be provided.

In one embodiment, delivery engine 710 may generate a response to the received media resource request and, in turn, transmit the response to the requestor. In one embodiment, delivery engine 710 may access a data structure, such as table 750 of FIG. 7B, to determine a network host address corresponding to a device known to host the requested media resource. For example, if a media resource request including a URL such as “start.real.com/rd?pid=CNN_222&URL=foo.smi” were to be received, where “CNN_222” represents a content identifier and “foo.smi” represents the requested media resource, one or more components of sample processing logic 606 may access table 750 using “CNN_222” to identify a host address of “media.cnn.com” for the requested media resource. Thereafter, sample processing logic 606 may generate a response URI such as “rtsp://media.cnn.com/foo.smi” or “http://media.cnn.com/foo.smi” depending e.g. upon whether the requested media resource is to be streamed to the requester. In one embodiment, the response URI is submitted to the requestor by delivery engine 710 as part of an HTTP (or RTSP) redirection response (as described above).

FIG. 7C is a logical block diagram illustrating one embodiment of sample processing logic 636 shown in FIG. 6 to further facilitate multiple entity control of dynamic media resource sampling. Sample processing logic 636 includes receive/transmit logic 732 for receiving and/or transmitting media resource requests from and/or to a requestor, token validation/authorization logic 734 and sample generation logic 736, as shown. In one embodiment, server 630 may utilize token validation/authorization logic 734 to independently validate/authenticate a token-equipped media resource request as originating from an authorized requestor. In one embodiment, such a validation process may include server 630 independently generating an obfuscated token using one or more dynamically ascertained request-specific and/or requestor-specific attributes in accordance with a token generation specification mutually recognized by both servers 602 and server 630. The validation process may further include server 630 performing a comparison between the independently generated token and the obfuscated token received in the media resource request. If the two tokens are deemed to be equivalent (whether exactly or within an acceptable margin of error away), the received token may be considered validated and the requestor may be considered authenticated. Thereafter, server 630 may deliver the requested media resource or a sample of the requested media resource depending e.g. upon the construct of the request.

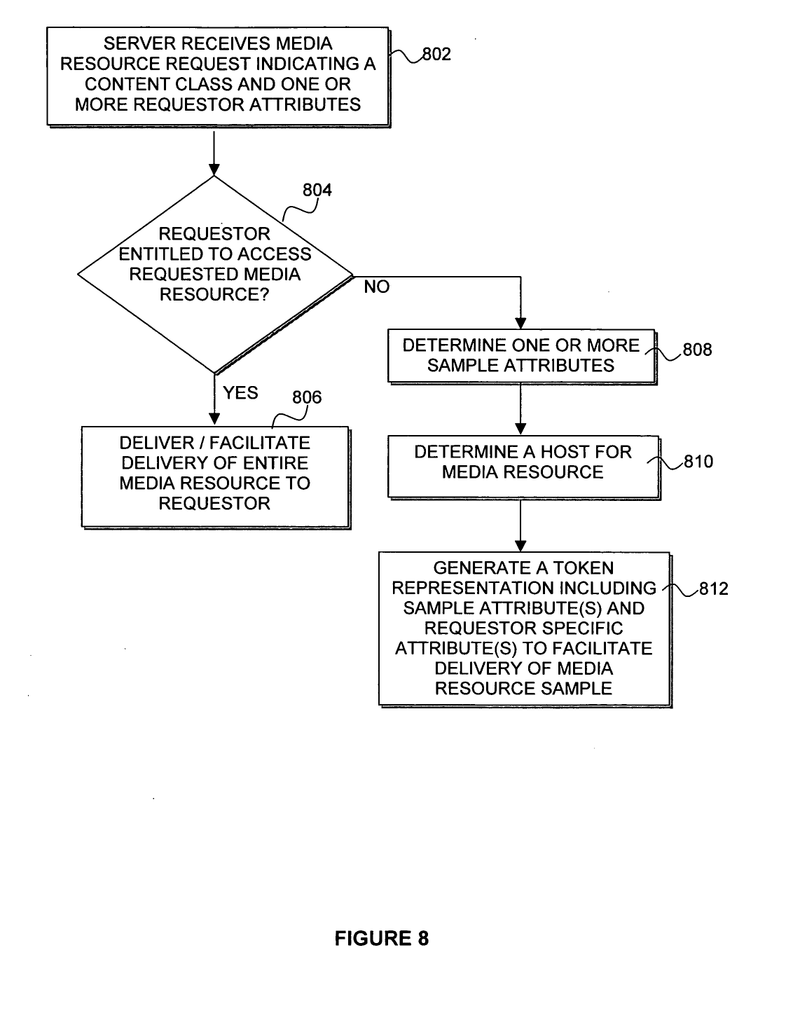

FIG. 8 illustrates an operational flow for one embodiment of a server equipped with sample processing logic 606 to facilitate multiple entity sample processing. As shown, the process may begin with the server receiving a request for a media resource, where the request indicates a content class associated with the requested media resource, and one or more attributes associated with the requester, block 802. In response, a determination is made as to whether the requester is entitled to access the requested media resource, block 804. If it is determined that the requester is entitled to access the requested media resource, the server either delivers or facilitates in the delivery of the entire media resource to the requestor, block 806. If, however, it is determined that the requestor is not entitled to access the requested media resource, the server determines/identifies one or more sample attributes (block 808), determines/identifies a device hosting the media resource (block 810), and generates a token representation, including the sample attributes and requestor specific attributes, to facilitate in the delivery of the media resource by the identified host, block 812.

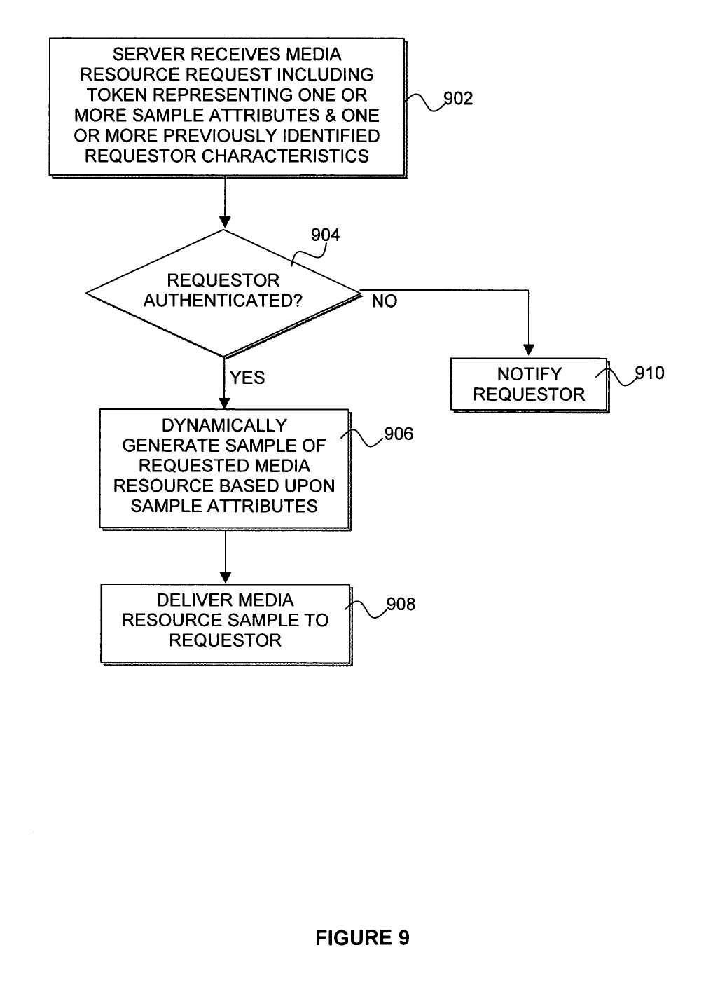

FIG. 9 illustrates an operational flow for one embodiment of a server equipped with sample processing logic 636 to further facilitate multiple entity sample processing. As shown, the process may begin with the server receiving a media resource request including a token representing one or more sample attributes and one or more previously identified requestor characteristics, block 902. At block 904, an attempt is made to authenticate the requestor. If the requester is not authenticated, the request is declined and the requestor notified accordingly, block 910. If, however, the requestor is authenticated, a sample of the requested media resource is dynamically generated based upon the sample attributes included within the token representation, block 906. Thereafter, the requested media resource is delivered to the requestor, block 908.

Example Client/Server Architecture

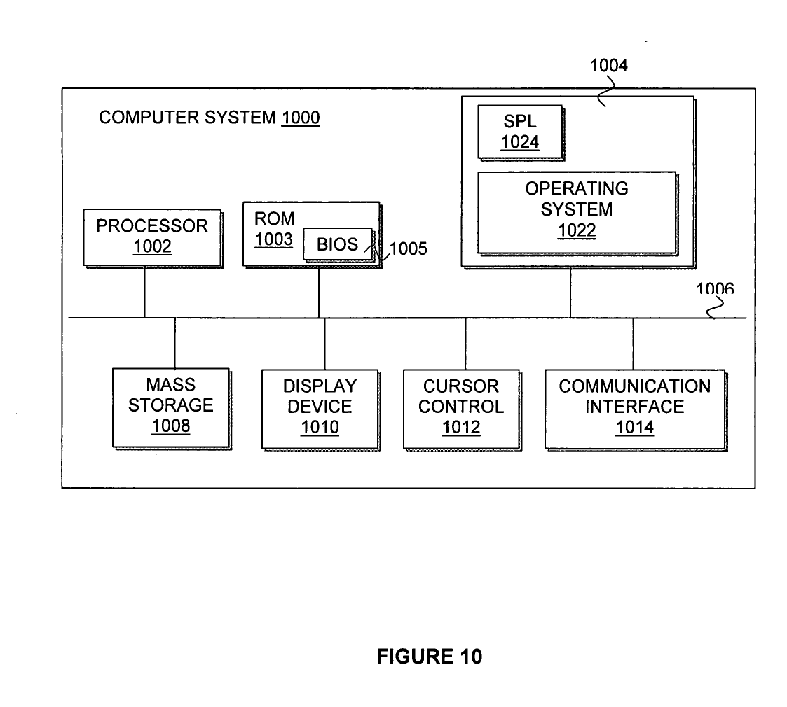

FIG. 10 illustrates an example computer system suitable for practicing the present invention. As shown, example computer system 1000 includes processor 1002, ROM 1003 including basic input/output system (BIOS) 1005, and system memory 1004 coupled to each other via “bus” 1006. Also coupled to “bus” 1006 are non-volatile mass storage 1008, display device 1010, cursor control device 1012 and communication interface 1014. During operation, memory 1004 may include working copies of operating system 1022, and sample processing logic (SPL) 1024 of the present invention to facilitate dynamic generation of media resource samples.

Except for the teachings of the present invention as incorporated herein, each of these elements may represent a wide range of these devices known in the art, and otherwise performs its conventional functions. For example, processor 1002 may be a processor of the Pentium® family available from Intel Corporation of Santa Clara, Calif., which performs its conventional function of executing programming instructions of operating system 1022 and sample processing logic 1024, including those implementing the teachings of the present invention. ROM 1003 may be EEPROM, Flash and the like, and memory 1004 may be SDRAM, DRAM and the like, from semiconductor manufacturers such as Micron Technology of Boise, Id. Bus 1006 may be a single bus or a multiple bus implementation. In other words, bus 1006 may include multiple properly bridged buses of identical or different kinds, such as Local Bus, VESA, ISA, EISA, PCI and the like.

Mass storage 1008 may represent disk drives, CDROMs, DVD-ROMs, DVD-RAMs and the like. Typically, mass storage 1008 includes the permanent copy of operating system 1022 and sample processing logic 1024. The permanent copy may be downloaded from a distribution server through a data network (such as the Internet), or installed in the factory, or in the field. For field installation, the permanent copy may be distributed using one or more articles of manufacture such as diskettes, CDROM, DVD and the like, having a recordable medium including but not limited to magnetic, optical, and other mediums of the like.

Display device 1010 may represent any of a variety of display types including but not limited to a CRT and active/passive matrix LCD display, while cursor control 1012 may represent a mouse, a touch pad, a track ball, a keyboard, and the like to facilitate user input. Communication interface 1014 may represent a modem interface, an ISDN adapter, a DSL interface, an Ethernet or Token ring network interface and the like.

Epilog

While the present invention has been described in terms of the above-illustrated embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A method comprising:
receiving a request for a media resource;
determining whether a requestor of the media resource is entitled to access the requested media resource;
delivering the requested media resource in its entirety to the requestor if it is determined that the requestor is entitled to access the requested media resource; and
dynamically generating a sample of the requested media resource and delivering the sample of the requested media resource to the requester if it is determined that the requester is not entitled to access the requested media resource.

2. The method of claim 1, wherein the request indicates at least a class of content to which the requested media resource belongs and an entitlement level associated with the requestor.

3. The method of claim 2, wherein determining whether the requestor is entitled to access the requested media resource further comprises determining whether the entitlement level associated with the requestor is equal to or is greater than an entitlement level associated with the class of content to which the requested media resource belongs.

4. The method of claim 3, wherein dynamically generating a sample comprises identifying a starting point and duration for the sample within the requested media resource based at least in part upon the class of content to which the requested media resource belongs.

5. The method of claim 4, further comprising:
generating a token representation to associate the requestor with the request for the media resource, wherein the token includes a representation of the starting point and duration for the sample and one or more requestor-specific attributes; and
transmitting the token representation to a predetermined host of the requested media resource to facilitate streaming of the sample of the requested media resource to the requester.

6. The method of claim 1, wherein the sample of the requested media resource is streamed to the requestor if it is determined that the requestor is not entitled to access the requested media resource.

7. The method of claim 1, further comprising:
generating an obfuscated token including a representation of a starting point and duration for the sample and one or more requestor-specific attributes; and
providing the token to a predetermined host of the requested media resource to facilitate streaming of the sample of the requested media resource to the requestor.

8. The method of claim 1, further comprising:
dynamically determining, based upon one or more attributes included within the request, a starting point within the media resource and a duration for which to sample the requested media resource.

9. A method comprising:
receiving a request for a media resource from a requester, the request indicating at least a content class to which the requested media resource belongs and one or more requestor attributes;
determining whether the requestor is entitled to access the requested media resource based at least in part upon the content class and the requester attributes; and
identifying one or more sample attributes to facilitate delivery of a sample of the requested media resource to the requestor if it is determined that the requester is not entitled to access the requested media resource.

10. The method of claim 9, further comprising:
facilitating delivery of the requested media resource in its entirety to the requestor if it is determined that the requestor is entitled to access the requested media resource.

11. The method of claim 9, wherein determining whether the requester is entitled to access the requested media resource further comprises determining whether the one or more requestor attributes represent an entitlement level that is equal to or greater than an entitlement level associated with the content class.

12. The method of claim 11, wherein identifying one or more sample attributes comprises identifying a starting point within the requested media resource and a duration for which the media resource is to be sampled based at least in part upon the class of content to which the requested media resource belongs.

13. The method of claim 12, further comprising:
determining a host of the requested media resource;
generating a token for the media resource, wherein the token represents the starting point and duration for the sample and at least a subset of the one or more requestor-specific attributes; and
returning the token and host identifying information to the requestor to facilitate streaming of the sample by the host to the requestor.

14. A method comprising:
receiving from a requestor, a request for a media resource, the request including a token representing one or more sample attributes to facilitate generation of a sample of the requested media resource, and one or more previously identified requestor characteristics;
authenticating the requestor based at least in part upon the one or more previously identified requestor characteristics;
dynamically generating a sample of the requested media resource based upon the one or more sample attributes; and
delivering the sample to the requestor.

15. The method of claim 14, wherein authenticating the requestor further comprises:
dynamically identifying one or more characteristics of the requester;
determining if the dynamically-identified requestor characteristics are equivalent to the previously identified requestor characteristics; and
authenticating the requestor if the dynamically-identified requestor characteristics are determined to be equivalent to the previously identified requestor characteristics.

16. The method of claim 14, wherein the sample of the requested media resource is streamed to the requestor.

17. The method of claim 14, wherein the sample attributes comprise a sample starting point indicating a starting point within the requested media resource for the sample, and a sample duration time indicating the length of the sample.

18. The method of claim 14, wherein the sample attributes comprise a sample starting point indicating a starting point within the requested media resource for the sample, and a sample size indicating a maximum storage size for the sample.

19. The method of claim 14, where in the one or more requestor-specific attributes represent at least one of a network address, a user-agent type, a user-agent version, and a globally unique identifier.

20. A recordable medium having instructions stored thereon, which when executed, implement a method comprising:
receiving a request for a media resource;
determining whether a requester of the media resource is entitled to access the requested media resource;
dynamically generating a sample of the requested media resource and delivering the sample of the requested media resource to the requestor if it is determined that the requestor is not entitled to access the requested media resource; and
delivering the requested media resource in its entirety to the requester if it is determined that the requestor is entitled to access the requested media resource.

21. The recordable medium of claim 20, wherein the request indicates at least a class of content to which the requested media resource belongs and an entitlement level associated with the requester.

22. The recordable medium of claim 21, wherein instructions to determine whether the requester is entitled to access the requested media resource further comprise instructions to determine whether the entitlement level associated with the requestor is equal to or is greater than an entitlement level associated with the class of content to which the requested media resource belongs.

23. The recordable medium of claim 22, wherein instructions to dynamically generate a sample comprise instructions to identify a starting point and duration for the sample within the requested media resource based at least in part upon the class of content to which the requested media resource belongs.

24. The recordable medium of claim 23, wherein the method further comprises:
generating a token representation to associate the requestor with the request for the media resource, wherein the token includes a representation of the starting point and duration for the sample and one or more requestor-specific attributes; and
transmitting the token representation to a predetermined host of the requested media resource to facilitate streaming of the sample of the requested media resource to the requestor.

25. The recordable medium of claim 23, wherein the sample of the requested media resource is streamed to the requestor if it is determined that the requestor is not entitled to access the requested media resource.

26. The recordable medium of claim 20, wherein the method further comprises:
generating an obfuscated token including a representation of a starting point and duration for the sample and one or more requestor-specific attributes; and
providing the token to a predetermined host of the requested media resource to facilitate streaming of the sample of the requested media resource to the requestor.

27. The recordable medium of claim 20, wherein the method further comprises:
dynamically determining, based upon one or more attributes included within the request, a starting point within the media resource and a duration for which to sample the requested media resource.

28. A recordable medium having instructions stored thereon, which when executed, implement a method comprising:
receiving a request for a media resource from a requester, the request indicating at least a content class to which the requested media resource belongs and one or more requestor attributes;
determining whether the requestor is entitled to access the requested media resource based at least in part upon the content class and the requestor attributes; and
identifying one or more sample attributes to facilitate delivery of a sample of the requested media resource to the requestor if it is determined that the requestor is not entitled to access the requested media resource.

29. The recordable medium of claim 28, wherein the method further comprises:
facilitating delivery of the requested media resource in its entirety to the requestor if it is determined that the requestor is entitled to access the requested media resource.

30. The recordable medium of claim 28, wherein determining whether the requester is entitled to access the requested media resource further comprises determining whether the one or more requester attributes represent an entitlement level that is equal to or greater than an entitlement level associated with the content class.

31. The recordable medium of claim 30, wherein identifying one or more sample attributes comprises identifying a starting point within the requested media resource and a duration for which to sample the media resource based at least in part upon the class of content to which the requested media resource belongs.

32. The recordable medium of claim 31, wherein the method further comprises:
determining a host of the requested media resource;
generating a token for the media resource, wherein the token represents the starting point and duration for the sample and at least a subset of the one or more requestor-specific attributes; and
returning the token and host identifying information to the requester to facilitate streaming of the sample by the host to the requestor.

33. A recordable medium having instructions stored thereon, which when executed, implement a method comprising:
receiving from a requestor, a request for a media resource, the request including a token representing one or more sample attributes to facilitate generation of a sample of the requested media resource, and one or more previously identified requestor characteristics;
authenticating the requester based at least in part upon the one or more previously identified requestor characteristics;
dynamically generating a sample of the requested media resource based upon the one or more sample attributes; and
delivering the sample to the requester.

34. The recordable medium of claim 33, wherein authenticating the requestor further comprises:
dynamically identifying one or more characteristics of the requestor;
determining if the dynamically-identified requester characteristics are equivalent to the previously identified requester characteristics; and
authenticating the requester if the dynamically-identified requester characteristics are determined to be equivalent to the previously identified requestor characteristics.

35. The recordable medium of claim 33, wherein the sample of the requested media resource is streamed to the requestor.

36. The recordable medium of claim 33, wherein the sample attributes comprise a sample starting point indicating a starting point within the requested media resource for the sample, and a sample duration time indicating the length of the sample.

37. The recordable medium of claim 33, wherein the sample attributes comprise a sample starting point indicating a starting point within the requested media resource for the sample, and a sample size indicating a maximum storage size for the sample.

38. The recordable medium of claim 33, where in the one or more requestor-specific attributes represent at least one of a network address, a user-agent type, a user-agent version, and a globally unique identifier.

39. An apparatus comprising:
receiving logic operative to receive a request for a media resource and determine whether a requestor of the media resource is entitled to access the requested media resource;
sample generation logic operative to dynamically generate a sample of the requested media resource if it is determined that the requestor is not entitled to access the requested media resource; and
transmission logic operative to deliver the sample of the requested media resource to the requestor if it is determined that the requestor is not entitled to access the requested media resource, the transmission logic further operative to deliver the requested media resource in its entirety to the requester if it is determined that the requestor is entitled to access the requested media resource.

40. The apparatus of claim 39, further comprising:
token generation logic operative to generate an obfuscated token including a representation of starting point and duration for the sample and one or more requestor-specific attributes, wherein the transmission logic further provides the obfuscated token to a predetermined host of the requested media resource to facilitate streaming of the sample of the requested media resource to the requester.

41. The apparatus of claim 39, wherein the sample generation logic is further operative to dynamically determine, based upon one or more attributes included within the request, a starting point within the media resource and a duration for which to sample the requested media resource.

42. An apparatus comprising:
receiving logic operative to receive a request for a media resource from a requestor, the request indicating at least a content class to which the requested media resource belongs and one or more requester attributes;
authorization logic operative to determine whether the requestor is entitled to access the requested media resource based at least in part upon the content class and the requestor attributes; and
sample generation logic operative to identify one or more sample attributes to facilitate delivery of a sample of the requested media resource to the requestor if it is determined that the requestor is not entitled to access the requested media resource.

43. The apparatus of claim 42, wherein the authentication logic is further operative to determine whether the one or more requestor attributes represent an entitlement level that is equal to or greater than an entitlement level associated with the content class.

44. The apparatus of claim 42, further comprising:
token generation logic operative to determine a host of the requested media resource, and generate a token for the media resource, wherein the token represents a starting point and a duration for the sample and at least a subset of the one or more requester attributes; and
delivery logic operative to return the token and host identifying information to the requestor to facilitate streaming of the sample by the host to the requestor.

45. An apparatus comprising:
receiving logic operative to receive a request for a media resource from a requestor, the request including a token representing one or more sample attributes to facilitate generation of a sample of the requested media resource, and one or more previously identified requester characteristics;
authenticating logic operative to authenticate the requestor based at least in part upon the one or more previously identified requestor characteristics;
sample generation logic operative to dynamically generating a sample of the requested media resource based upon the one or more sample attributes; and
delivery logic operative to deliver the sample to the requestor.

46. The apparatus of claim 45, wherein the authentication logic is further operative to:
dynamically identify one or more characteristics of the requestor;
determine if the dynamically-identified requestor characteristics are equivalent to the previously identified requestor characteristics; and
authenticate the requestor if the dynamically-identified requestor characteristics are determined to be equivalent to the previously identified requestor characteristics.

47. The apparatus of claim 45, wherein the sample attributes comprise a sample starting point indicating a starting point within the requested media resource for the sample, and a sample duration time indicating the length of the sample.
